(19) United States
(12) Patent Application Publication
(10) Pub. No.: US 2004/0202119 A1
(43) Pub. Date: Oct. 14, 2004

(54) Base station synchronization in a wireless network

(76) Inventor: Stephen William Edge, Escondido, CA (US)

Correspondence Address: Siemens Corporation, Intellectual Property Department, 170 Wood Avenue South, Iselin, NJ, 08830, US

(21) Appl. No.: 10/410,843

(22) Filed: Apr. 10, 2003

(51) Int. Cl. H04B 7/212

(52) U.S. Cl. 370/324

(57) ABSTRACT

A wireless communications network and method of synchronizing network base stations. Wireless mobile units, e.g., cell phones, periodically measure transmission timing differences between pairs of adjacent base stations and each provide the measurements to a server base station. An absolute transmission timing difference (ATD) is determined for each difference measurement. ATDs are collected and combined for each pair of base stations. A timing relationship is developed for all base stations from the combined ATDs. A timing correction is extracted for each base station from the timing relationship. Application of the timing corrections synchronizes the base stations.

### BACKGROUND OF THE INVENTION

1. Field of the Invention

The present invention is related to wireless communications systems and networks and, more particularly, to synchronization of transmission timing in wireless network base stations.

2. Background Description

Wireless communication systems, such as those supporting Global System for Mobile Communication (GSM), Time Division Multiple Access (TDMA) and Code Division Multiple Access (CDMA) technologies, employ a base station in each cell or cell sector. Each base station supports wireless communication to and from the mobile units in that cell or cell sector. Mobile units may include handsets, PDAs, laptops and other devices with a wireless communications interface. Very precise and stable transmission timing is required at each base station and is organized, according to the wireless technology supported, into different types of time units and sub-units.

In some technologies, e.g., CDMA, the transmission timing of all base stations must be precisely synchronized such that it is precisely the same at each base station. In other wireless technologies, e.g., GSM and TDMA, the transmission timing at any base station can be independent of that at any other base station. In these technologies where base station timing synchronization is not essential for normal wireless operation, it is well known that synchronization can improve the performance of certain features and can increase network capacity.

Typically, base station synchronization is achieved by using common and very precise Global Positioning System (GPS) timing. A GPS receiver in or connected to each base station provides a precise GPS timing reference that is derived from signals received from one or more GPS satellites. All base stations schedule specific transmission events—e.g., the start of transmission of the first bit in a particular GSM frame—at exactly the same GPS time instant.

GPS receivers, however, tend to be expensive and require additional effort and expense to install and support. In addition, base stations providing wireless coverage in dense urban areas or indoors (e.g. shopping mall) may not have very clear GPS signal reception, making GPS receiver usage more problematic.

Thus, there is a need to synchronize base stations without the need for deploying GPS receivers. There is a further need to synchronize base stations without any other hardware modification to existing networks and with no impact to the supported mobile units.

### SUMMARY OF THE INVENTION

It is a purpose of the invention to maintain base station synchronization in wireless networks;

It is another purpose of the invention to improve base station synchronization in existing wireless networks;

It is yet another purpose of the invention to improve base station synchronization in existing wireless networks without adding hardware or modifying existing hardware;

It is yet another purpose of the invention to improve and maintain base station synchronization in existing wireless networks that do not include universal clock timing receivers and without adding hardware or modifying existing hardware;

It is yet another purpose of the invention to improve and maintain GSM base station synchronization in base stations that do not include local Global Positioning System (GPS) receivers.

The present invention relates to a wireless communications network and method of synchronizing network base stations. Wireless mobile units, e.g., cell phones, periodically measure transmission timing differences between pairs of nearby base stations and each provide the measurements to a local server base station. An absolute transmission timing difference (ATD) is determined for each difference measurement. ATDs are collected and combined for each pair of base stations. A timing relationship is developed for all base stations from the combined ATDs. A timing correction is extracted for each base station from the timing relationship. Application of the timing corrections synchronizes the base stations.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 shows an example of a preferred embodiment wireless network;

FIG. 2 shows an example of a base station synchronization flow diagram with reference to the wireless network of example of FIG. 1;

FIG. 3 shows a graphical example of another method of averaging the ATDs in the system of FIG. 1;

FIG. 4 shows another graphical example of averaging the ATDs in the system of FIG. 1;

FIG. 5 shows an example of a flow diagram for graphically reducing errors between network base stations as in the examples of FIGS. 3 and 4;

FIG. 6 shows a flowchart of an example of an alternate error measurement method that may be used to reduce independent time difference errors;

FIG. 7 shows an example a conceptual graph generated for the method of FIG. 6 from the wireless network of FIG. 1;

FIG. 8 shows a graphical representation of adjusting base station timing for n+1 (n≧1) base stations over the maximum transmission timing unit (T) before wraparound.

### DESCRIPTION OF PREFERRED EMBODIMENTS

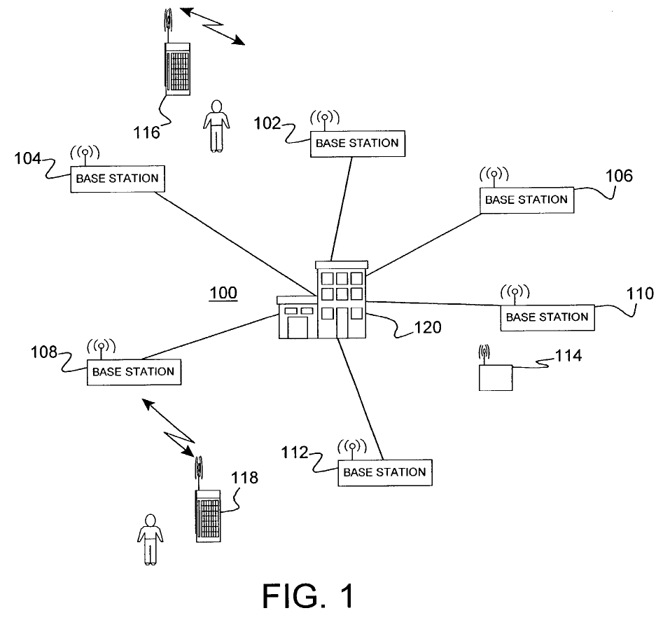

Turning now to the drawings and, more particularly, FIG. 1 shows an example of a preferred embodiment wireless network 100 or system, e.g., a Global System for Mobile Communication (GSM) network, a Time Division Multiple Access (TDMA) network, Code Division Multiple Access (CDMA) network or an equivalent network. Optionally, one or more fixed measurement units 114 may be dispersed throughout the system or subsystem reception area. The wireless network 100 serves mobile stations or units 116, 118 within reception range of at least one of the base stations 102, 104, 106, 108, 110, 112. Mobile units 116, 118 may include cellular phone handsets (cell phones) or other devices with a wireless communications interface, e.g., a computing device such as a personal digital assistant (PDA), laptop computer or tablet computer and etc. Base station transceivers (BTS), also commonly referred to simply as “base stations,” 102, 104, 106, 108, 110, 112 are connected to a central entity or central network unit 120, which may be a base station controller (BSC) in a base station subsystem (BSS) or, for a GSM system, a serving mobile location center (SMLC) or an equivalent. The connection from each BTS to a BSC, SMLC or other central network entity may employ a direct transmission link—for example a wired connection, microwave link, Ethernet connection. Alternately, the connection may be by one or more intermediate entities—e.g. an intermediate BSC in the case of a connection from a BTS to an SMLC for GSM.

Each mobile unit 116, 118 periodically measures the transmission timing difference between pairs of base stations 102, 104, 106, 108, 110, 112. So, for example, mobile unit 116 measures the difference in transmission timing for communication from its serving base station 104 and from one or more neighboring base stations, e.g., 102 and/or 108. Either the mobile unit or, preferably, the base station removes differences attributed primarily to propagation delays between the mobile unit and base station antennas to produce an absolute timing difference (ATD). The absolute timing difference or, ATD, is the difference that would result if external propagation delays (antenna to mobile unit) were all identical, i.e., if antenna of base stations 102, 104, and/or 108 were all co-located or if the mobile unit was equidistant from both base station antennas.

The measurements are expressed in the transmission units and sub-units of the particular wireless technology. Normally, the overall frequency band for any GSM wireless operator is divided into 200 kilohertz (KHz) physical channels. Within each 200 KHz physical channel, the base station transmits at a defined fixed rate of approximately 270.833 Kbits/second. The overall transmission bit sequence can contain short periods of silence equivalent to the transmission time of a certain number or fraction of bits and is organized hierarchically into frames and various assemblages of frames. The longest assemblage of frames in GSM, the hyperframe, contains 2,715,648 individual frames numbered consecutively from 0 up to 2,715,647. Each frame contains 8 timeslots and each timeslot normally contains 156.25 bits. Timeslots within a frame are likewise numbered from 0 up to 7 and bits within a timeslot are numbered from 0 up to 156, where bit numbers between 0 and 155 represent whole bits and bit number 156 represents the final 0.25 bit time in a frame. Quarter bit periods are also numbered in each time slot from 0 through 624. The quarter bit period is the smallest explicitly maintained transmission interval in GSM and is equal to 12/13 microseconds. So, in a GSM network the measured difference may be in bits and fractions of a bit or in frames, timeslots, bits and fractions of a bit or in assemblages of frames (multiframes), frames, timeslots, bits and fractions of a bit. Similarly, in a CDMA network, the measured difference may be in chips and fractions of a chip rather than in bits.

Preferably, after extracting ATDs from mobile units 116, 118, each serving base station 102, 104, 106, 108, 110, 112 aggregates or combines the ATDs for each pair of base stations, e.g., 102 and 104, 104 and 108. ATDs for a particular pair of base stations may be combined either with a running average (N-sample or over time period [symbol] ) or a running weighted average. Each serving base station 102, 104, 106, 108, 110, 112 provides the aggregated ATDs to the central entity 120. Alternatively, the serving base stations 102, 104, 106, 108, 110, 112 provide the ATDs directly to the central entity 120, which then aggregates or combines the ATDs. The central entity 120 uses the aggregated ATDs to calculate a transmission timing adjustment for each base station (e.g., 108) to synchronize it with the other base stations (102, 104). The central entity 120 sends the calculated timing adjustments to each corresponding base station 102, 104, 106, 108, 112, where transmission timing is adjusted gradually in small steps, either forwards or backwards and, spread over a period of time sufficient to make the adjustment.

Typically, each base station 102, 104, 106, 108, 110, 112 maintains counters (not shown) indicating a count for the current transmission with count numbers for each timing unit of the particular communications technology. Thus, each GSM base station has a frame number counter, a time slot number counter, a bit number counter and quarter bit number counter. These counters increment according to timing information derived internally from a single local frequency source with absolute accuracy better than 0.05 parts per million (ppm). The base station also uses the same frequency source to generate the transmission frequency, i.e., 850 or 1900 MHz in North America and 900 or 1800 MHz elsewhere. The same counters are associated with all of the 200 KHz physical channels supported by the base station, synchronizing local transmission from that one base station. The counters are also explicitly and implicitly conveyed by each base station in certain control channels, e.g., the synchronization channel in GSM. So, any mobile unit is able to derive the exact counter values in the transmission arriving from any monitored base station after a period of monitoring base station transmission. Maintaining these counters and their application synchronized to base station transmission frequency provides a local GSM timing reference at the base station which can be measured by mobile units.

Mobile units 116, 118 continually measure, and base stations 102, 104, 106, 108, 110, 112 continually extract, ATDs and forward the ATDs to the central entity 120. The central entity 120 may aggregate ATDs and, continually provides synchronization adjustments to the base stations 102, 104, 106, 108, 110, 112. When base stations restart (e.g., following recovery from failure or some maintenance activity) or upon start up, they are similarly synchronized with other base stations. The amount of startup adjustment may be greater than for up and running base stations and, typically, may be necessary before the base station is providing wireless service to any mobile units. In some GSM variants, the number of bits in a timeslot is not fixed at 156.25 but rather set to 157 bits in timeslots 0 and 4 in any frame and to 156 bits in the remaining 6 timeslots in that frame. Provided mobile units are aware of this, they make appropriate adjustments to synchronize with base station timing.

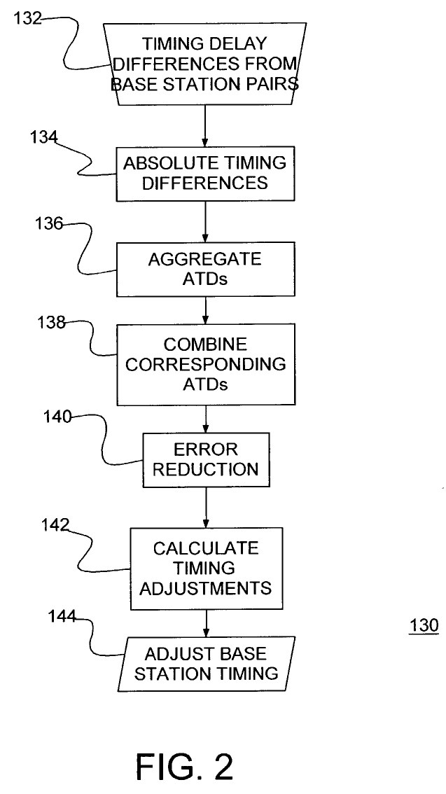

FIG. 2 shows an example of a flow diagram 130 of base station synchronization in a wireless network according to a preferred embodiment of the present invention with reference to the subsystem example of FIG. 1. The base station synchronization method of the present invention obviates the need for a common source clock, e.g., from a local Global Positioning System (GPS) receiver. For simplicity of illustration, the first, serving or current base station is represented in the discussion hereinbelow by base station 104 and the mobile unit is represented by mobile unit 116 unless indicated otherwise. The second or handover base station is taken to refer to base station 102. Further, this is for example only and not intended as a limitation as any base station is a handover station for any wireless unit entering its reception range and serves as a serving base station for wireless units in its reception range.

First in step 132 wireless entities or wireless units, e.g., mobile units 116, 118, measure transmission timing differences between pairs of base stations 102, 104, 106, 108, 110, 112, e.g., between mobile unit 116 and each of base station pair 102, 104 or 102, 106. Optionally, fixed measurement units, e.g., 114, at known locations throughout the network also measure transmission timing differences between pairs of base stations 102, 104, 106, 108, 110, 112. Next in step 134 an absolute timing difference (ATD) is derived for each measured difference to remove the portion of the delay difference corresponding to the difference in propagation time between the mobile unit 116, 118 and each of the base station antennas. The ATDs are extracted from the measured time difference (MTD) and satisfies the relationship

MTD=(ATD+(P2−P1)) (1)

where P1 and P2 represent the propagation time between the particular mobile unit, e.g., 116, and each of the base stations, e.g., 102, 108, and where time differences represent transmission timing from the base station associated with propagation time P1 less the transmission timing from the base station associated with propagation time P2. In step 136 the ATDs are combined or aggregated, combining ATDs for each base station pair, measured at different mobile units and/or at different points in time. Preferably this aggregation of ATDs occurs in the serving base station 102, 104, 106, 108, 110, 112 for the mobile unit making the measurement. In step 138 ATDs from different base stations and for each pair are combined, preferably in the central unit 120. Next, in step 140 timing difference measurement errors are reduced, e.g, graphically or using weighted averages as described hereinbelow. Then, in step 142 a timing adjustment is calculated for each base station 102, 104, 106, 108, 110, 112 and provided to the corresponding base station 102, 104, 106, 108, 110, 112. In step 144 each base station 102, 104, 106, 108, 110, 112 gradually adjusts its timing until the base stations 102, 104, 106, 108, 110, 112 are synchronized with each other. Optionally, a selected base station(s) may include a precise universal time source, such as a GPS receiver, for further improved and stable synchronized network timing.

The timing differences measured in step 132 can be expressed either as a complete time value or, a relative time value, relative to some transmission timing sub-unit. A complete time value expresses the complete time difference—for example, the number of GSM frames, timeslots, bits and fractions of a bit by which the transmission timing of one base station differs from that of another base station. A relative timing difference expresses the difference relative to some sub-unit of transmission—for example a frame or a timeslot in GSM—and omits the portion of the complete time difference that contains a whole number of these sub-units.

For example, a GSM mobile unit (e.g., 118) observes a base station 108 to send the start of bit 57 of timeslot 3 in GSM frame 2395 and, at the same time observes base station 112 to have sent a fraction 0.78 of bit 23 of timeslot 7 in GSM frame 35704. The mobile unit 118 can compute the complete transmission timing difference to be the time B from base station 112 less the time A from base station 108; which is 33309 (=35704−2395) frames, 4 (=7−3) timeslots, −34 (=22−56) bits and a fraction (0.78) of bit. Re-expressing this resulting difference using only positive values and since one timeslot normally contains 156.25 bits; the positive (complete time) difference is 33309 frames, 3 timeslots and 123.03 bits. However, the difference relative to a single GSM frame, omitting the number of whole frames (33309) results in a difference of 3 timeslots and 123.03 bits. Relative to a GSM timeslot, the difference further reduces to just 123.03 bits. Similarly, the complete time difference may be expressed using a single time unit for the wireless technology, e.g., converting the above complete difference example to bits results in 41,636,841.78 bits. Further, any number N may be selected for a modulo N conversion of a complete difference to a relative difference, e.g., for N=256, the complete difference (41,636,841.78 modulo 256) is 233.78 bits.

Also, the difference measurements may be made under a number of different conditions. In a state of the art GSM system, for example, any mobile unit can perform a timing measurement during handover from one “old” base station to another “new” base station, if ordered to do so by the old base station. The handover measurement provides the difference in transmission timing between the old and new base stations. This transmission timing difference provides the difference in the timing of the two base stations in half bits, relative to (modulo) 2²¹ half bit periods and, thus can be accurate to plus or minus one quarter of a bit. Also a typical state of the art GSM system can instruct mobile units that support the well known enhanced-observed timing difference (E-OTD) positioning method to measure the timing difference between the serving base station and certain neighboring base stations. This positioning timing difference is expressed relative to only a single GSM time slot in bits and fractions of a bit with a minimum resolution of 1/256 bit. In addition to handover or positioning measurements, mobile units can measure timing differences between base stations under many other conditions including, but not limited to, periodic measurement and measurement ordered by the network for the specific purpose of synchronizing base stations.

As noted herinabove, the absolute time difference determined in step 134 is the time difference that would be observed by the mobile unit if the propagation delay from each base station was the same—for example, if the two base stations (or, more exactly, the antennas of the two base stations) were at the same location or if the mobile station was equidistant from both base stations. The well known equation (1), above, shows the necessary adjustment to the measured time difference to obtain the absolute time difference between two base stations. Whenever the propagation delay between the mobile unit and both of the base stations can be determined, the measured time difference can be used (preferably, by the particular mobile unit) in the above equation (1) to determine the absolute time difference, which then may be provided to the serving base station. Otherwise, if only the propagation delay between the mobile unit and one base station is known in the mobile unit; then, part of the adjustment can be performed in the mobile unit. For example, if the propagation delay between the mobile unit and base station (P1) is known, then, using the above terminology, the mobile unit can provide the value of (MTD+P1) to the serving base station. Then, according to equation (1), the value for P2 is subtracted by the serving base station to obtain the ATD. Otherwise, without at least this partial adjustment in the mobile unit, the serving base station would need to obtain the values for both P1 and P2 to calculate the ATD from the provided MTD.

This partial adjustment can be used in a GSM system, for example, when the current base station (104) transmission signal becomes blocked or is severely attenuated or, when the mobile unit 116 is ordered to perform handover from an old serving base station 104 to some new serving base station 102. The propagation delay to the base station 104 is determinable from the GSM timing advance value used to synchronize transmission from the mobile unit 116 to transmission from the base station 104. The timing advance value is double the propagation delay, making derivation of the propagation delay straightforward. For a specific type of GSM handover, known as pseudo-synchronized handover, the mobile unit 116 always provides this partially adjusted value to the new serving base station 102. For other types of GSM handovers the partially adjusted value can be determined and forwarded if ordered by the old base station 104. Then, similarly, after the handover the new base station 102 can obtain the value for the second propagation delay (P2) from the new timing advance value. The new serving base station 102 can thus obtain the absolute time difference between itself and the old base station 104. In a variant of the GSM measurement method, the mobile unit 116 waits until after the handover to the new base station 102 and it obtains a new timing advance value to the new base station 102. The mobile unit 116 then obtains the propagation delays to both the old and the new base stations 104, 102 and, thereby, obtains the absolute time difference before sending this difference to the new base station 102.

Optionally, each base station 102, 104, 106, 108, 110 can pass the ATDs between it and its neighboring base stations directly to the central entity 120 of combination/aggregation. This approach works well when network signaling resources can handle the higher signaling requirements for passing the raw/unaggregated ATDs to the central entity without interfering with other network signaling traffic and, when the central entity has the numbering crunching capability to handle the very large number of received ATD measurements.

Otherwise, preferably, the serving base station 102 combines/aggregates the ATDs for each pair of base stations that it receives or derives from different mobile units into a single statistically averaged value. Each aggregate ATD is forwarded to the central entity 120 in any of a number of ways. For example, the serving base station 104 stores each ATD value that it receives or derives for a pair of base stations (e.g., 102, 106). The number of values stored may be for a certain period of time or until a certain number of values have been stored. Then, the base station 104 calculates the arithmetic average of all the stored values and transfers this average to the central entity. When the base stations have the local capacity to store a very large number of measurements, the base stations may collect and transfer statistics on the variability of the values that have been averaged. For example, the base station can include the variance or standard deviation of the values and the number of them, to indicate to the central entity the accuracy and reliability of the average value. This option requires minimal change in the time difference between two base stations during the measurement storage. Such changes impair accuracy because the earlier measurements will not accurately reflect the change compared to later (post change) measurements.

However, preferably, the ATDs are aggregated using a moving weighted average. As is well known in the art, a moving weighted average can be obtained for N samples by applying a weight (w) to each of the samples according to the following equations:

ATD₁=ATD₁ (2)

ATDₙ₊₁(1−w)ATDₙ+wATDₙ₊₁(n≧1) (3)

Where ATDₙ is the nth measurement (n≧1) of absolute time difference received or derived from a mobile unit, ATDₙ is the moving weighted average of ATD₁ measurements for i=1 to N, and for the weight w where 0<w<1.

A low weight value (w close to zero) is used if the absolute time difference between base stations changes only very slowly, which it normally does in wireless networks since base station timing is required to be extremely precise and stable. A higher value (w closer to 1) might be used if the time difference could change significantly over a short period. The variability and reliability of the moving weighted average can also be expressed using the standard deviation or variance of the values of (ATDₙ−ATDₙ₊₁) in the above equations. ATD averaging or weighted averaging may be done at any convenient point in the network. For example, if the central entity 120 has the capacity to perform the averaging, the individual ATD measurements may be forwarded directly to the central entity 120. In this example, the base stations may provide measured or absolute timing differences to the central entity 120. An SMLC serving as the central network entity 120 is capable of performing the E-OTD positioning method. The measured (or “observed”) GSM time differences are passed to the SMLC central entity 120 which obtains and aggregates the individual ATDs as described hereinabove.

Furthermore, if optional fixed measurement units 114 are deployed at known locations throughout a network, each fixed measurement unit 114 can measure the timing differences between one and, preferably, many pairs of nearby base stations 102, 104, 106, 108, 110, 112. The fixed measurement units 114 can then either forward the difference measurements or use equation (1) to extract the ATDs from the measured time differences. Since the distance between the fixed measurement unit 114 and each nearby base station 102, 104, 106, 108, 110, 112 can be known, the propagation delays can be derived fairly easily. For example, GSM systems with a GSM SMLC central network entity are capable of supplying such measurements from location measurements units (LMUs) in place to support E-OTD positioning. However, typical LMUs for E-OTD do not normally support network synchronization.

Once the central entity has in its possession average values for the absolute time differences between different pairs of base stations; in step 138 it can perform further averaging of the time differences between different pairs of base stations to yield still more accurate and reliable values. In the simplest case, the central entity 120 may have been provided with, or have itself obtained, the average absolute time difference between some base station 104 and some other base station 102 as expressed with base station 102 time subtracted from base station 104 time. The central entity 120 may also have obtained or been provided with the time difference expressed as base station 104 time subtracted from base station 102 time. This would occur for example, if time differences were derived using pseudo-synchronized GSM handover capability. Mobile units that have just been handed over provide each serving base station 102, 104, 106, 108, 110, 112 with values for the timing of a neighbor base station less its own. In this example, each of the two neighboring base stations, e.g., 102, 104, would provide the central entity 120 with a distinct (possibly different) value for the time difference between them but expressed with opposite arithmetic signs. Other base stations 106, 108, 110, 112 (or mobile units or fixed measurement units directly) may provide other values for this time difference. To achieve a more accurate single value for the time difference between the pair of base stations 102, 104, the central entity 120 may simply average all received ATD values for the particular pair, ignoring any arithmetic sign difference. However, preferably the central entity 120 performs a weighted average of the received ATD values with a higher weight assigned to any value with a lower variation (e.g., with a lower standard deviation or variance) or obtained from a higher number of component measurements.

For very small ATD differences between base stations pairs (e.g. if the base stations are already closely synchronized), an arithmetic sign change may be due to error as well as which base station's time was subtracted from the other. So, if the central entity 120 knows which base station's time was subtracted from the other base station's time, it can change the sign of values where needed so that the same base station's time is subtracted for all values. The absolute time difference values will then remain signed and can be averaged with the sign included.

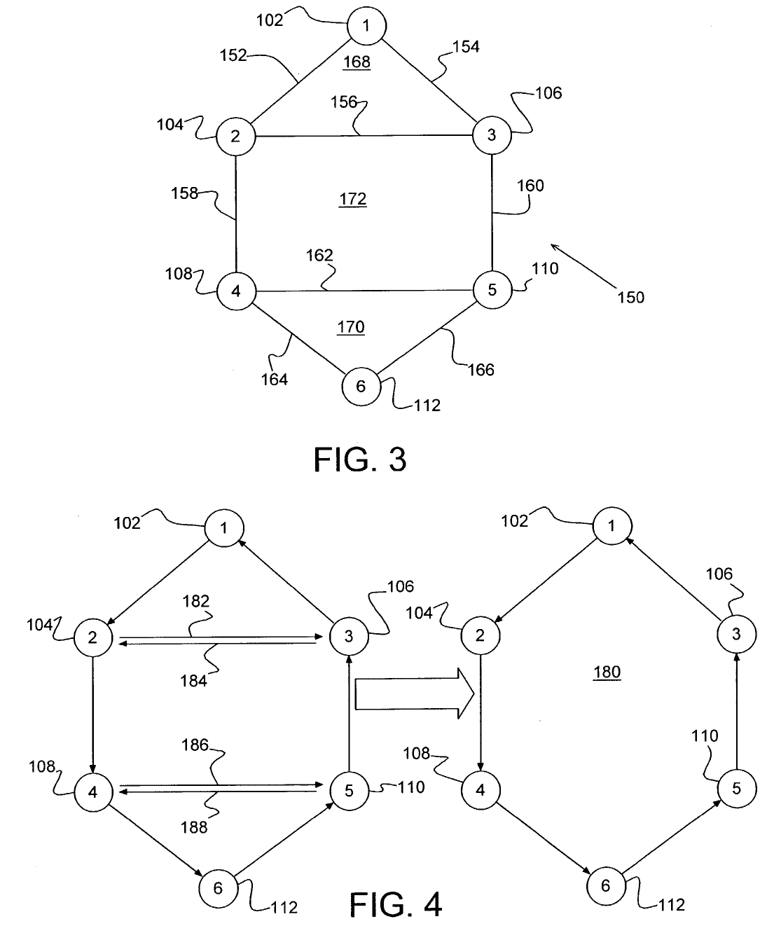

FIG. 3 shows a graphical example of another method of averaging the ATDs in the system of FIG. 1 with each of the base stations 102, 104, 106, 108, 110, 112 represented as nodes labeled 1, 2, 3, 4, 5, 6 in the network graph 150. In this example, the central entity 120 can average the values between the same pair of base stations as described. Each ATD is represented by a link 152, 154, 156, 158, 160, 162, 164, 166, which denotes the availability of an averaged measurement of the absolute timing difference that has been obtained between the pair of base stations connected. Then, values can be averaged around various closed loops 168, 170, 172 in the network graph 150. In this example, the closed loop 168 contains the links 152, 154 and 156; the closed loop 170 contains the links 162, 164 and 166; and the closed loop 172 contains the links 156, 158, 162 and 160.

The time differences in traversing a path around any closed loop 168, 170, 172 should add up to zero, provided they are measured correctly and consistently (e.g. with time differences expressed as the difference of each succeeding base station's timing in the loop less that of the previous base station). For example, in the loop 168 for a path from base station 102 to base station 104 to base station 106 and back to base station 102, with each base station time being identified by a subscript for the corresponding number in each node, the following should be true:

(T₂−T₁)+(T₃−T₂)+(T₁−T₃)=0 (4)

where Tₙ=current timing at base station node n(1<=n<=6) (5)

However, since the averaged measured values of the absolute time differences may contain small errors, the above equation may not hold exactly. Instead, in step 140, the equation can be used to estimate the errors as follows:

$$\begin{matrix}Let {T}_{i j} = absolute measured time difference between & ( 6 ) \\ base station node i and base station node j & \\ = average of [ ( measured timing at j ) - & \\ ( measured timing at i ) ] & \\ and {e}_{i j} = error in {T}_{i j} & ( 7 ) \\ = ( {T}_{j} - {T}_{i} ) - {T}_{i j} & \end{matrix}$$

then equation (4) above yields

(T₁₂+e₁₂)+(T₂₃+e₂₃)+(T₃₁+e₃₁)=0 (8)

Since the values for T₁₂, T₂₃ and T₃₁ are known, equation (8) provides a relationship between the error values e₁₂, e₂₃ and e₃₁ for loop 168. Other closed loops 170, 172 can be used to obtain more relationships between the error values. For example, the two loops 170, 172 containing the base stations 108, 112, 110 and 104, 108, 110, 106, respectively, provide:

(T₄₆+e₄₆)+(T₆₅+e₆₅)+(T₅₄+e₅₄)=0 (9)

(T₂₄+e₂₄)+(T₄₅+e₄₅)+(T₅₃+e₅₃)+(T₃₂+e₃₂)=0 (10)

It should be noted that no other independent equations for the error values can be obtained in the network graph 150 of FIG. 3 using other loops, because every other closed loop that can be obtained is a combination of two or all three of the loops 168, 170, 172 so far considered.

For example, consider the closed loop 180 of FIG. 4 from base station 102 to 104 to 108 to 112 to 110 to 106 and back to 102. This is equivalent to combining the 3 previous closed loop paths 168, 170, 172 in graph 150 and removing the links 182, 184 and 186, 188 with two opposite directions of travel. The relationship between the error values in this case is given by:

(T₁₂+e₁₂)+(T₂₄+e₂₄)+(T₄₆+e₄₆)+(T₆₅+e₆₅)+(T₅₃+e₅₃)+(T₃₁+e₃₁)=0 (11)

The above equation (11) can be obtained by adding together all three of the previous equations, (8), (9) and (10), and using the fact that for any pair of base station nodes i and j, Tᵢⱼ equals −Tⱼᵢ and eᵢⱼ equals −eⱼᵢ. Thus, it can be seen in the above example that while there are six error values, there are only three independent equations relating them. A solution for all six error values requires further assumptions. For example, certain pairs of error values could be assumed to be equal.

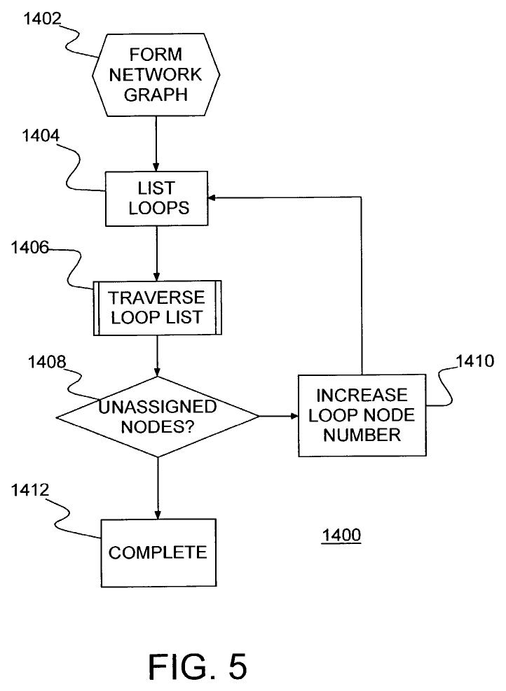

FIG. 5 shows an example of a flow diagram 1400 for graphically reducing errors between network base stations as in the examples of FIGS. 3 and 4. First in step 1402, a conceptual network graph is formed, e.g., 150 in FIG. 3, representing base stations as nodes and all available ATD measurements or averaged ATD measurements between pairs of base stations represented as the links between the corresponding nodes. Then in step 1404, a loop node number is set to 3 and in step 1406 groups of all distinct closed loops with just 3 distinct nodes are formed into an ordered list (the list ordering is arbitrary). In step 1408 the list is checked for the listed loops. Unless the list is empty because no such loops exist, in step 1410 traversing through the ordered list in descending order, loops with all links appearing in previously traversed loops are removed. Each of the remaining listed loops provides one equation relating three error values for its three links. Next, in step 1412 the graph is checked to determine if any links remain that have not been assigned to a traversed loop but could be assigned to a new (non-traversed) loop. If any remain then, in step 1414 the number of nodes is increased to 4 and in step 1406 an ordered list is generated of all distinct closed loops containing 4 distinct nodes. Again in step 1408, the list is checked for the listed loops. If no such loops exist, then skipping step 1410 and continuing to step 1412 the graph is checked to determine if any links remain. Otherwise, in step 1410 all 4 node loops with links appearing in either any preceding (4 node) loop or any of the remaining 3 node loops are removed. Each of the 4 node loops still remaining in the list provides one equation relating four error values for its four links. Again, in step 1412 the graph is checked to determine if any links remain that are not assigned to a remaining loop. If any remain then the number of nodes is increased in step 1414 and steps 1406, 1408 and 1410 are repeated for 5 node loops, 6 node loops and so on until in step 1412 all links in the network have been included in at least one loop or links remain that cannot be assigned to any loop. Once no links or loops remain, in step 1414 the graphical analysis is complete. Thus, the central entity achieves more accurate values for the time differences between base stations and, in particular, more consistent values such that any sequence of time differences around a closed loop sums to the required zero value.

Optionally, iterative steps 1404, 1406, 1408, 1410 can be replaced with a single step of forming an ordered list of all closed loops in the network in a single operation to achieve the same result. This single list is organized such that loops with fewer nodes appear earlier in the list than loops with more nodes. As in the example of FIG. 5, loops with links that appear in loops earlier in the list are removed from the list.

In the above described examples, any loop can be removed from the lists when all of its links appear in previously considered loops because, for each link in a removed loop, the timing difference error represented by that link can be expressed in terms of the timing difference errors for other links, i.e., in an equation already considered for some prior loop containing that link. Thus, timing difference error equations are redundant for removed loops and could be derived from equations for previously considered loops. However, when at least one link in a loop is not included in any previously considered loop; then, this loop adds a new independent timing difference error equation. The timing error equation includes one timing error variable not appearing in any equation for previously traversed loops.

As a result of the example of FIG. 5, each loop (or each equation) includes at least one unique timing difference error not appearing in any other loop (or other equation) and the first equation has at least 3 timing difference errors, i.e., is derived from at least 3 links. So, the number of equations can never exceed the number of timing difference errors less two. In other words, the result always has at least two fewer equations than are required to solve for all errors. So, as noted above, some additional assumptions are needed to solve for all error values. Expressing each additional assumption as an equation involving one or more error values, the number of such equations (if independent) required to solve for all error values will equal the number of links (i.e., distinct error values) appearing in the closed loops (i.e. equations) less the number of closed loops (distinct equations) remaining in the ordered list(s).

In step 142 of FIG. 2, the central entity (120 in FIG. 1) arbitrarily selects a reference base station and calculates timing differences to every other base station. Using the graph 150 of FIG. 3, the control entity 120 finds paths along the links between the pairs of nodes from the reference base station to the other base stations. The timing differences, which are known for each link are summed to determine the timing differences along the sequence of links. For example, referring to FIG. 1, if base station 102 is selected as the reference, the timing difference to base station 112 can be obtained as (T₁₃+T₃₅+T₅₆), where the Tᵢⱼ values now represent error corrected timing differences following application of the error reduction, e.g., 1400 in FIG. 5. This produces consistent results. So, the same time difference is obtained using any path, e.g., the path producing the sum (T₁₂+T₂₄+T₄₆). If a path cannot be found to some base stations from the reference base station, which may occur occasionally, then different discrete portions of the network are synchronized separately. Discrete portion is synchronized substantially identically, as described here, obtaining time differences such as use of handover measurements or E-OTD measurements in GSM.

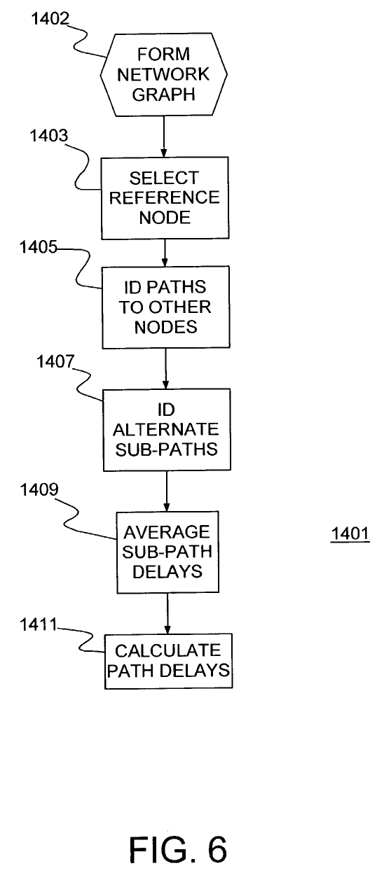

FIG. 6 shows a flowchart of an example of an alternate error measurement method 1401 that may be used to reduce errors in step 140. The method is particularly suitable when the errors in the time differences are independent of one another though it may be applied when the errors are interdependent. The method of this example does not require arbitrary assumptions for certain time differences to improve accuracy in reported time differences between base stations. First in step 1402 a conceptual network graph is produced. In step 1403 a reference node (base station) is chosen. Then, in step 1405 paths are identified to any other node from the reference node. Paths containing the fewest number of links are selected and with each link appearing in just one path. Limiting each link to just one path prevents accumulation (correlation) of the same delay error for any link that might otherwise occur if the link was used in several paths when the delays for these paths are averaged. Provided each link is used only once, independent positive and negative errors cancel and tend to reduce the delay error in the final averaged delay. The variance of the averaged delays gradually reduces because of independence between the delays being averaged. Further, using as many paths as possible enables greatest reduction in delay error (due to averaging more independent values) while using shortest paths ensures minimum delay error on any one path. Once all paths have been obtained, in step 1407 alternative sub-paths for portions of each path that use previously untried links are found. Then, in step 1409 the delay over the alternative sub-paths are averaged to determine the delay over every portion of a path. Portions of any sub-path can be likewise obtained using alternative sub-paths provided the links being used were not already assigned to some other path or sub-path. Next in step 1411 the whole path delay is calculated. For a fixed wireless network topology, the precise choice of paths and sub-paths may be determined and optimized in advance to reduce the amount of calculation needed in the central entity.

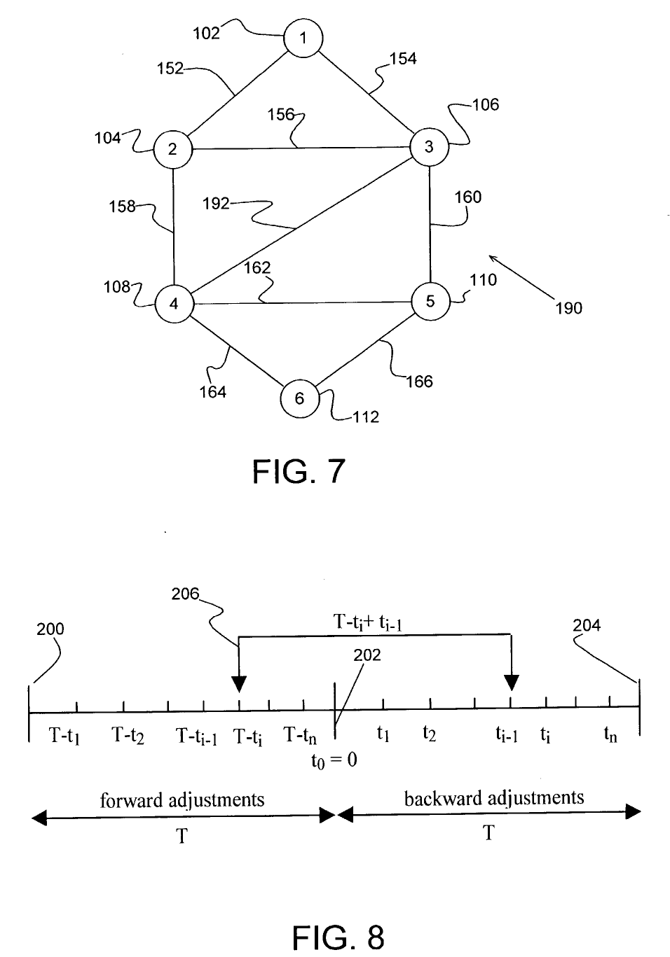

FIG. 7 shows an example a conceptual graph 190 generated in step 1402 of FIG. 6 from the wireless network 100 of FIG. 1. Conceptual graph 190 is substantially similar to the graph 150 of FIG. 3 with like elements labeled identically and each of base stations 102, 104, 106, 108, 110, 112 provided with a corresponding node number 1, 2, 3, 4, 5, 6, respectively. In this example, an additional delay difference 192 is included between base stations 106 and 108. So, in step 1403 some arbitrary reference node (e.g., node 1 corresponding to base station 102) is chosen. Then, an average timing difference value is calculated for every other node in the network by obtaining the timing differences from the reference node 1 (base station 102) for as many paths as possible to the other node, giving preference to the shortest possible paths and such that each link only appears in one path. Node 4 (base station 108), for example, can be reached on paths with 2 or more links from node 1. The shortest paths involve just 2 links, the following two alternatives:

Path 1: node 1→node 2→node 4

Path 2: node 1→node 3→node 4.

The ensuing time difference with node 4 may be obtained by summing the delay differences between the pairs of nodes along each path above. Errors in the absolute timing difference values between nodes may be assumed to be independent random variables, each with the same variance and a mean of zero (due to positive and negative errors canceling one another). Although it is not required that the errors be independent and random, this facilitates and improves timing measurement accuracy.

$$\begin{matrix}Let V = variance of the error in any timing & ( 12 ) \\ difference measurement & \\ = variance of the measurement of any timing & \\ difference ( where it is assumed that any timing & \\ difference has some fixed value while & \\ being measured ) & \\ = VAR ( {e}_{i j} ) ( for any two distinct nodes i and j & \\ connected by a link ) & \\ = VAR ( {T}_{i j} ) & ( 13 )\end{matrix}$$

It should be noted that for any particular timing difference measurement, the error variance is the same as the measurement variance because the measurement includes a fixed value (the true timing difference at the time the measurement is made) plus the random error.

$$\begin{matrix}Let T ( N1 , N2 , N3 … Nm ) = delay difference on a path & ( 14 ) \\ from node N1 to N2 to N3 … to Nm & \\ = ( {T}_{N1N2} + {T}_{N2N3} + {T}_{N3N4} + … + {T}_{Nm \text{-} 1 Nm} ) & \\ then delay for Path 1 = T ( 1 , 2 , 4 ) & \\ = {T}_{12} + {T}_{24} ( variance = 2 V ) & ( 15 ) \\ delay for Path 2 = T ( 1 , 3 , 4 ) & \\ = {T}_{13} + {T}_{34} ( variance = 2 V ) & ( 16 )\end{matrix}$$

Equations (15) and (16) include in parentheses the variance for the calculated delay (and thus the variance in the error in the calculated delay) for each path. This calculated delay variance is simply twice the variance V for the delay on any one link due to assuming independent errors. The two time delays calculated using either path will not in general be equal due to different errors but can be averaged to yield a single statistically more accurate result as follows.

$$\begin{matrix}mean delay on paths 1 and 2 = [ ( delay for path 1 ) + & ( 17 ) \\ ( delay for path 2 ) ] / 2 & \\ = ( {T}_{12} + {T}_{24} + {T}_{13} + {T}_{34} ) / 2 & \\ ( variance = V ) & \end{matrix}$$

The variance of the mean delay (and thus the variance of the error in the mean delay) has been reduced to V, according to well known statistical results. Thus, the mean delay in equation (17) is more accurate than that obtained using either single path alone in equations (15) and (16). This more accurate delay can be improved, slightly, by replacing the hop from node 3 (base station 106) to node 4 for path 2 by two sequential hops from node 3 to node 5 (base station 110) and node 5 to node 4. The time delay and variance of the time delay across these alternative paths are:

T(3,4)=T₃₄(variance=V) (18)

T(3,5,4)=T₃₅+T₅₄(variance=2V) (19)

The two delays from equations (18) and (19) can be averaged to yield a more accurate delay between nodes 106 and 108. However, because the two delays above have a different variance, a weighted average must be employed to minimize delay variance. Preferably, the weighting is based on a well known theorem in statistics in which the variance of the weighted average of a set of independent random variables is minimized by assigning a weight to each random variable that is inversely proportional to its variance. The delay is then given as follows.

$$\begin{matrix}Let {T}_{34}^{*} = averaged delay from node 3 to node 4 & ( 20 ) \\ = 2 / 3 [ {T}_{34} + ( {T}_{35} + {T}_{54} ) / 2 ] ( variance = 2 / 3 V ) & \end{matrix}$$

The more accurate delay, T₃₄*, in equation (20) with a variance of only 2V/3 can now be substituted for the delay T₃₄ in equation (18). This improves Path 2 delay as follows:

$$\begin{matrix}improved delay for Path 2 = {T ( 1 , 3 , 4 )}^{*} & ( 21 ) \\ = {T}_{13} + {T}_{34}^{*} ( variance = 5 / 3 V ) & \end{matrix}$$

This improved delay, T(1, 3, 4)*, for path 2 can now be combined with the delay T(1, 2, 4) for path 1 to yield a delay from node 1 to node 4 with a lower variance than before. Using a weighted average to minimize the variance, this is:

improved delay on paths 1 and 2=10/11[T(1,2,4)/2+3/5T(1,3,4)*](variance=10/11V) (22)

This variance of the delay in equation (22) is slightly less than that obtained in equation (17). Further, even though no delay difference was measured directly between the reference node 1 and node 4, the resulting calculated delay difference in equation (22) is slightly more accurate than the result from any directly measured delay differences between pairs of nodes. An additional very small improvement in the delay difference from node 1 to node 4 can be obtained by replacing the hop from node 5 to 4 (for the alternate path from node 3 to 4 going via node 5) with hops from node 5 to 6 and node 6 to 4. Obtaining the delay from node 5 to 4 as a weighted average of the delays on these alternative paths can reduce the delay variance for this part of the path and lead to similar (though smaller) reductions in the path delay variance when gradually worked back into the delay from node 1 to node 4.

When instead of complete ATDs, relative ATDs are provided, the central entity 120 can calculate timing differences from some reference base station to any other base station as described hereinabove. However, in this case the calculated timing differences are only relative to the sub-unit of transmission used for the provided measurements. Time difference summations and averaging as described above is performed relative to the transmission sub-unit. So, only the fractional portion of the sub-unit in any sum or average would be significant and any integer multiple of the sub-unit in such a result is discarded. The same convention applies to the maximum unit of transmission for any wireless technology (e.g. the hyperframe in GSM) when complete timing differences are provided. In this case also, only fractions of the maximum transmission unit in any result are considered significant.

Occasionally, the measurements provide relative timing differences but, the measured transmission delays are provided relative to a sub-unit that falls short of what is needed for synchronization; i.e., the measured delays are relative to a sub-unit that is not equal to or a multiple of the minimum sub-unit necessary for base stations synchronization. As set forth below, base station timing adjustments can be calculated from these otherwise inadequate relative timing measurements to achieve synchronization using some additional information.

Referring again to the wireless network 100 of FIG. 1, first each base station 102, 104, 106, 108, 110, 112 periodically provides the central entity 120 with its current complete timing reference. For example, each base station 102, 104, 106, 108, 110, 112 includes its current complete timing reference whenever it provides the central entity 120 with measured time differences for pairs of base stations 102, 104, 106, 108, 110, 112. As shown below, this enables the central entity 120 to calculate the complete timing differences between base stations 102, 104, 106, 108, 110, 112, provided the maximum error range in the complete timing value for any base station 102, 104, 106, 108, 110, 112, after reaching the central entity 120, is less than the sub-unit relative to which timing differences are measured.

The primary sources of complete transmission timing reference errors, generally, are transmission delay uncertainty (from each base station to the central entity 120) and time maintenance errors in the central entity 120. Although the transmission delay from each base station to the central entity can be estimated either by prior calculation or by real time measurements, generally, it is never known exactly. If the central entity 120 adds an estimate for this delay to the timing reference from some base station 102, 104, 106, 108, 110, 112, it can have an estimate for the current timing reference at the time of reception. If the central entity 120 also records the time of receipt using its own clock source, it can calculate the base station timing reference at any later time by adding in the amount of elapsed time. If the central entity 120 follows the same procedure for other base stations, 102, 104, 106, 108, 110, 112, it can derive estimates for the complete timing differences between pairs of base stations 102, 104, 106, 108, 110, 112 by taking the differences in these estimated time references.

Let S=sub-unit of transmission timing for the measured delay differences

t*=accurate delay difference relative to S between 2 base stations A and B obtained from measurements with 0≦t*<S

Let n S+t=lower bound for the estimated complete time difference between A and B (23)

n S+t+E=upper bound for the estimated complete time difference between A and B (24)

where E<S, 0≦t≦S and n≧0 (n is an integer) (25)

As noted above, provided the maximum error range (E) is less than the sub-unit of transmission timing for the measured delays (E<S) the precise complete delay difference can be derived as follows.

$$\begin{matrix}precise complete time difference = ( n S + {t}^{*} ) if {t}^{*} \geq t & ( 26 ) \\ = ( ( n + 1 ) S + {t}^{*} ) if {t}^{*} < t & ( 27 )\end{matrix}$$

Equations (26) and (27) follow from the restriction that the precise complete time difference must be within the range given in equations (23) and (24) and must be an integer multiple of S plus the accurate difference t* relative to S.

Having derived precise complete timing differences between some reference base station (e.g., 104) and all other base stations (102, 106, 108, 110, 112) in the network using the above methods; the central entity 120 can calculate a timing adjustment for each base station 102, 104, 106, 108, 110, 112, necessary to synchronize all base stations 102, 104, 106, 108, 110, 112. If complete timing synchronization is needed, then the complete timing differences themselves give the needed timing adjustments, which can be expressed in either a forward or backward direction.

FIG. 8 shows a graphical representation of adjusting base station timing for n+1 (n≧1) base stations (e.g., 102, 104, 106, 108, 110, 112 in FIG. 1) over the maximum transmission timing unit (T) before wraparound according to a preferred embodiment of the present invention. For base stations 102, 104, 106, 108, 110, 112 in this example, n is 6 and the reference base station is taken as 102. The base stations 102, 104, 106, 108, 110, 112 are also assigned distinct indices from 1 to n. Denote the backward adjustment time for any base station i by tᵢ, i.e., tᵢ is the amount of time by which base station i leads the reference base station. Thus, adjusting timing for the i^{th} base station backwards by an amount tᵢ synchronizes it with the reference base station. For this example, base stations are indexed such that base station timing satisfies t₀≦.t₁≦.t₂≦.t₃≦. . . . ≦.tₙ.

It should be noted that, since the reference base station 102 has zero time adjustment, it can be indexed zero with t₀ (202) equal to zero. For any base station i with backward adjustment time tᵢ, the forward adjustment time is T−tᵢ. Since T is the wraparound time for the timing in every base station, the timing for base station i can either be adjusted backwards by an amount tᵢ or forwards by an amount T−tᵢ to bring it into synchronization with the reference base station. This is illustrated graphically in FIG. 8, where the point tᵢ is represented positively and lies at a distance tᵢ to the right of to representing the amount of backward adjustment for base station i, and the point T−tᵢ is represented negatively and lies at a distance T−tᵢ to the left of t₀ representing the amount of forward adjustment for base station i. The maximum amount of adjustment will always be less than T in both the backward direction (toward 204) and forward direction (toward 200).

To minimize the overall time range over which adjustments are needed for all base stations, it suffices to find a minimum value in the following set:

{tₙ, T−tₙ+tₙ₋₁, T−tₙ₋₁+tₙ₋₂, . . . , T−t₂+t₁, T−t₁+t₀}

Any value (T−tᵢ+tᵢ₋₁) in the above set (represented by the range 206 in FIG. 8) gives the overall range of timing adjustment when backward adjustments are used for base stations 1 to i−1 and forward adjustments are used for base stations i to n. The initial value tₙ gives the overall range of timing adjustments when backwards adjustments are used for all base stations 1 to n. Thus, the minimum value in this set minimizes the total range of forward and backward adjustments.

Once the minimum adjustment range 206 has been found (e.g., T−tᵢ+tᵢ₋₁), the midpoint in the range can be chosen as a new timing reference in order to minimize the maximum adjustment over all base stations. Alternatively, the timing of one base station (with an odd number of base stations) or the timing somewhere between the timings for a pair of base stations (with an even number of base stations) in the middle of the range can be chosen as a timing reference to minimize the total amount of adjustment summed over all base stations. Having selected a new reference base station and so, a new timing reference, the existing timing adjustments within the minimum range are adjusted by a fixed addition or subtraction to zero the time adjustment for the new reference. For example, if base station 104 has index land t₁ (and thus base station 104) is selected as the new reference, then the amount t₁ is added to any forward adjustment and subtracted from any backward adjustment for each remaining base station 102, 106, 108, 110, 112. In the general case of base station i, for example, which previously had a timing adjustment of T−tᵢ in the forward direction, the new adjustment would be T−tᵢ+t₁ in the forward direction.

As an example, for GSM, some base station A may have a complete timing difference with respect to a reference base station R of 2,328,107 frames, 5 timeslots and 59.8 bits in advance. The timing adjustment to base station A of this amount (i.e. of 2,328,107 frames, 5 timeslots and 59.8 bits) in a backward direction would bring the timing of base station A into alignment with R. However, GSM time wraps around once every hyperframe of 2,715,648 GSM frames. So, for the GSM variant with equal length 156.25 bit timeslots, the timing of A could be advanced in a forward direction by 2,715,648 frames less the backward adjustment which comes to 387,540 frames, 2 timeslots and 96.45 bits. The forward adjustment is less than the backward adjustment and so is easier to manage. The forward and backward adjustments can be obtained for all base stations. Then, a new reference time can be established to minimize the overall amount of time adjustment in the base stations as set forth above.

Some networks may not require complete time synchronization between base stations. For example, it may suffice to synchronize GSM base station timing relative to a GSM frame or, just to a GSM timeslot. In this example, the difference in timing between base stations need only be obtained relative to the transmission time sub-unit needed for synchronization. More extensive measurements that provide time differences relative to a larger transmission time sub-unit, e.g., complete timing differences (using any of the previous methods) may still be used to achieve synchronization relative to the smaller sub-unit provided the larger sub-unit is an exact integer multiple of the smaller. To achieve this, as before and with reference to FIG. 1, the central entity 120 selects a reference base station, e.g., 104. Complete time values (or time values relative to some larger sub-unit) are then obtained for other base stations 102, 106, 108, 110, 112 relative to the reference base station 104. These values are then divided by the smaller sub-unit needed for synchronization with the remainder of this division giving the time difference relative to the smaller sub-unit which can then be used for synchronization.

So, for example, if the complete time difference in GSM for some base station (e.g. 102) relative to the reference base station (e.g., 104) is 4097 frames, 2 timeslots and 87.6 bits, the time difference relative to a GSM frame is 2 timeslots and 87.6 bits and, relative to one timeslot is 87.6 bits. Once time differences relative to a particular sub-unit are obtained for all base stations, the necessary timing adjustments to achieve synchronization of base stations relative to this sub-unit and to minimize the maximum adjustment over all base stations can be obtained as described above.

So, in step 144 of FIG. 2, the central entity 120 transfers the calculated timing adjustments to the respective base stations 102, 104, 106, 108, 110, 112. Base stations 102, 104, 106, 108, 110, 112 make the required adjustment, e.g., by adjusting timing counters instantaneously according to the adjustment. For example, in a GSM system, each base station 102, 104, 106, 108, 110, 112 can adjust its frame, timeslot and bit counters. However, this immediate change for adjustment would disrupt current service and most likely lead to dropping of current calls and other services, e.g., packet connections, SMS and so on. So, preferably the adjustments are gradual, at a rate such that mobile units, e.g., 118, being served by the base station 112 can adjust their own clocks to keep pace. This gradual adjustment is particularly suitable if the synchronization sub-unit is very small because the time needed to complete the adjustment can then be small enough to achieve synchronization quickly.

For example, if GSM base stations are synchronized only at the GSM frame level, the maximum timing adjustment would be 4.615 milliseconds which is the duration of one GSM frame. However, if timing adjustments have been minimized (e.g., by choosing a reference base station with a median timing adjustment as described here previously), the maximum adjustment is halved or, approximately 2.3 milliseconds. GSM mobile units must re-synchronize their timing counters to the serving BTS every 1 to 2 seconds. If the serving base station were to adjust its timing by ¼ bit every second (¼ bit occupying 12/13 microseconds and being the smallest time unit in GSM), GSM mobile units would be able to keep pace and it would take up to nearly 2500 seconds (41.7 minutes) for the maximum adjustment. By contrast, if only timeslot synchronization is required (8 timeslots in one GSM frame), the maximum adjustment at this rate would take only 312.5 seconds or 5.2 minutes.

While a base station (e.g., 110) is adjusting its timing (particularly if this requires a long period of gradual adjustment), it is possible that the central entity 120 may be provided with further time difference measurements and need to calculate further adjustments to the base station 110. The central entity 120 has two alternatives to prevent any new adjustment from interfering with one already in progress, e.g., if a base station chose to continue completing the first adjustment before applying the second.

The central entity 120 can allow each base station 102, 104, 106, 108, 110, 112 to finish any previous adjustment before calculating a new adjustment. New adjustments must then be based on timing difference measurements made after each base station 102, 104, 106, 108, 110, 112 has completed its previous adjustment. Each base station 102, 104, 106, 108, 110, 112 could notify the central entity 120 when any particular adjustment had been completed, or the central entity might calculate this interval for itself if it knew the rate at which each base station applied an adjustment. This approach enables further adjustments of gradually increasing precision as the timings of all base stations 102, 104, 106, 108, 110, 112 converge to a common value through the sequence of adjustments. However, this may take significant time to synchronize all base stations, especially, since adjustments that were initially not completely accurate must first be allowed to complete before any further adjustment is permitted.

Alternatively, the central entity 120 can calculate new adjustments for some or all base stations 102, 104, 106, 108, 110, 112 while a previous set of adjustments is still underway—e.g. after most of the adjustment has been applied and base stations are more closely but not yet completely synchronized. The central entity 120 immediately passes the new adjustment to the respective base station 102, 104, 106, 108, 110, 112. Each base station 102, 104, 106, 108, 110, 112 stops any ongoing adjustment after receiving a new adjustment from the central entity 120. Then, the base stations 102, 104, 106, 108, 110, 112 proceed with the new adjustment. This may lead to synchronizing the base stations 102, 104, 106, 108, 110, 112 more quickly.

If a particular base station, e.g., 106, is out of synchronization by a significant amount, e.g., by an amount comparable to a GSM hyperframe, then gradual adjustment may take too long to be effective. To overcome this, the central entity 120 can maintain a common time reference (not shown) for all base stations 102, 104, 106, 108, 110, 112. The common time reference either may be linked to a clock in the central entity 120 or provided to the central entity 120 by some particular one of the base stations 102, 104, 106, 108, 110, 112 as described hereinabove. The central entity 120 can send the common time to any previously unsynchronized base station 106, e.g., when that base station 106 first starts operation or recovers from an operation or failure in which its transmission timing reference is lost. Then, the recipient base station 106 adjusts the common time value it has received by adding the expected signaling transit time from the central entity 120 to obtain the common time reference at the moment of reception. The base station can then synchronize its own transmission to this common time reference. The expected signaling transit time from the central entity can be estimated from previous measurements, e.g., by using half of the round trip signaling time between the base station 106 and central entity 120 to approximate the one way delay. Signaling delays in modern telecommunications networks are typically in the tens of milliseconds, e.g., on a standard 64 Kbps SS7 signaling link, a 500 bit signaling message has a transmission time of 7.8 milliseconds. So the transmission delay from the central entity to any base station, allowing for transmission on several links and through one or more intermediate entities (e.g. a base station controller) could typically range from a few tens to a few hundreds of milliseconds. Thus, even if the error in estimating the transmission delay were of the same magnitude, a typical base station could be synchronized with an error of a few tens of to a few hundred milliseconds at most.

As noted hereinabove, once the central entity 120 has transferred the common time to a base station, 102, 104, 106, 108, 110, 112, for the purposes of initial synchronization, it can provide periodic timing adjustment updates to bring any base station e.g., 108, into precise synchronization with other base stations 102, 104, 106, 110, 112. The subsequent adjustment may still be large (e.g. a few tens of to a few hundred milliseconds) and, thus, could still require significant adjustment time for synchronizing the base station 108 gradually enough to maintain wireless service to the mobile units, e.g., 118, supported in the base station's cell area. However, these supported mobile units 118 could be handed off to other base stations, e.g., 112, and/or allowed to complete their current service (e.g., complete a voice call) with no new services being provided to other mobile units. Once the base station 108 is no longer providing service to any mobile units, its timing could be adjusted at a faster rate. Alternately, the base station could restart wireless service and make the timing adjustment instantaneously. Following this synchronization, the base station 108 could resume providing service to mobile units again. Since this major adjustment usually is only needed when a base station first starts operation or, recovers from some failure or maintenance activity serious enough to lose timing, it need not cause serious disruption to overall network service.

For more accurate base stations synchronization and to help overcome random drift and fluctuation in the synchronized timing imposed by the central entity 120, one or more base stations (e.g., 110, 112) can contain or can be connected to a precise universal timing source, e.g., GPS time. Each connected base station or base stations synchronizes its own transmission timing in some pre-agreed manner to the precise universal time, obviating the need for any timing adjustments from the central entity. Then, the central entity 120 selects one of the connected base stations (e.g., 112) which serves as the reference base station. The central entity 120 synchronizes the remaining base stations 102, 104, 106, 108 as set forth above to the reference base station 112.

For yet further improved synchronization, where more than one base station (110, 112) is equipped with precise universal time, the central entity 120 can assign each as a reference base station. Then, the timing adjustment for any other base station 102, 104, 106, 108 is obtained from the timing difference with the reference base station 110 or 112 closest to it, i.e., the reference base station 110 or 112 with fewest links separating it from the other base station 102, 104, 106, 108 in the network graph, e.g., graph 190 in FIG. 7. The timing adjustment will tend to be more accurate with this improvement because, by reducing the number of links from any base station to a reference base station, it relies on the fewest number of absolute transmission timing differences between pairs of base stations and thus contains the fewest number of error components.

Alternatively, the base station or base stations with precise universal time access (110, 112) need not synchronize their timing locally but, instead just report their transmission timing reference together with the corresponding precise universal time (either complete or relative to some sub-unit) to the central entity 120. Then, the central entity calculates the synchronization timing adjustment to each base station 102, 104, 106, 108, 110, 112 as described hereinabove without the precise universal time correspondence. Next, once all base stations 102, 104, 106, 108, 110, 112 are approximately synchronized, the central entity uses the precise universal timing correspondence for the connected base stations equipped 110, 112 to synchronize all base stations 102, 104, 106, 108, 110, 112 to the precise universal time.

For example, an universal time equipped base station A, reports a transmission timing of t1 relative to a sub-unit of transmission u and a corresponding precise universal time of T1. A forward adjustment of t1* is first applied to base station A to achieve initial synchronization with all base stations independent of universal time. Then, after the adjustment the transmission timing of base station A relative to the precise universal time T1 becomes (t1+t1*) mod u, when the adjustment is extrapolated backwards. Later, base station A reports a transmission timing of t2 and a corresponding precise universal time of T2. Based on the earlier correspondence between (t1+t1*) mod u and T1, the central entity can calculate the transmission timing t2#, which would be expected at universal time T2, with perfect synchronization to universal time. Thus, the required adjustment for base station A to restore synchronization is [(t2#−t2) mod u] in a forward direction. Although a different adjustment may be needed for any other base station equipped with precise universal time, the application of such adjustments will restore universal time synchronization for those base stations equipped with precise universal time because they are synchronized to the same universal time. For any base station B not equipped with universal time, first the timing difference is calculated to some universal time equipped reference base station A, as described hereinabove, and from this the initial timing adjustment t3 in a forward direction is obtained, to synchronize to base station A. Then, the precise universal timing adjustment applied to A is added to this initial timing adjustment for an overall timing adjustment to B of [(t3+t2#−t2) mod u] in a forward direction. Applying this timing adjustment to B brings it into synchronization with the precise universal time equipped base station(s) A and with precise universal time.

Advantageously, a system according to the present invention seamlessly synchronizes base stations and maintains synchronization for improved performance. Further, the present invention has application to synchronizing base stations in wireless technologies that do not normally require synchronization for basic unenhanced operation. Base stations synchronize without hardware modification or modification to supported mobile units. Further, an independent clock source such as a GPS receiver is not required in wireless network base stations for synchronization.

While the invention has been described in terms of preferred embodiments, those skilled in the art will recognize that the invention can be practiced with modification within the spirit and scope of the appended claims.

What is claimed is:

1. A wireless communications network comprising:
a plurality of wireless mobile units;
a plurality of base stations, each of said plurality of wireless mobile units being in wireless communication with one or more of said plurality of base stations, each of said plurality of base stations being a server base station for wirelessly connecting to one or more of said wireless mobile units, each said server base station collecting timing differences from said wireless mobile units each receiving signals from at least two of said plurality of base stations; and
a central network entity, said plurality of base stations providing said collected timing differences to said central network entity, said central network entity determining a timing synchronization adjustment for each of said plurality of base stations from said collected timing differences, said central network entity providing to at least some of said plurality of base stations a corresponding said timing synchronization adjustment, each of said plurality of base stations adjusting base station transmission timing, whereby transmission timing synchronizes and is maintained synchronized among said plurality of base stations.

2. A wireless communications network as in claim 1, wherein said central network entity is a base station controller in a base station subsystem.

3. A wireless communications network as in claim 1, wherein said central network entity is a serving mobile location center for GSM.

4. A wireless communications network as in claim 1, wherein each said server base station extracts an absolute timing difference from said collected timing differences.

5. A wireless communications network as in claim 4, wherein each said server base station averages said extracted absolute timing differences for corresponding pairs of said base stations.

6. A wireless communications network as in claim 5, wherein averages of said absolute timing differences are moving weighted averages.

7. A wireless communications network as in claim 1, further comprising:
one or more fixed measurement units, each of said fixed measurement units being located at a known location.

8. A wireless communications network as in claim 7, wherein each of said fixed measurement units provides timing differences to one of said plurality of base stations.

9. A wireless communications network as in claim 1, wherein at least one base station includes a universal clock source, said at least one base station being synchronized to said local clock source.

10. A wireless communications network as in claim 9, wherein said universal clock source is a global positioning system (GPS) receiver.

11. A wireless communications network as in claim 9, wherein said central network entity bases timing synchronization adjustments on timing differences from said at least one base station, other ones of said plurality of base stations being synchronized to said at least one base station.

12. A wireless communications network as in claim 1, wherein said timing differences are relative timing differences.

13. A wireless communications network as in claim 1, wherein said central network entity forms a network graph representative of said communications network, each of said plurality of base stations being represented as a graph node, measured delay differences between pairs of said plurality of base stations being represented as links between pairs of corresponding representative nodes.

14. A wireless communications network as in claim 13, wherein paths between each pair of nodes define timing difference relationships between represented said base stations, said timing difference relationships relating errors in said timing differences between pairs of said represented base stations, said central network entity extracting related said errors.

15. A wireless communications network as in claim 13, wherein said central entity identifies an ordered list of distinct loops in said graphs, each distinct loop having at least one link not included in any earlier listed said distinct loop.

16. A wireless communications network as in claim 15, wherein said distinct loops define timing difference relationships between base stations represented by connected nodes on said distinct loops, said timing difference relationships relating errors in said timing differences between pairs of said base stations, said central network entity extracting related said errors.

18. A wireless communications network as in claim 1, wherein at least one of said plurality of mobile units is a cellular telephone.

19. A wireless communications network as in claim 1, wherein at least one of said plurality of mobile units is a computing device with a wireless communications interface.

20. A method for synchronizing base station transmission timing in a wireless network, said method comprising the steps of:
a) measuring timing differences between pairs of a plurality of base stations;
b) aggregating measured said timing differences;
c) combining aggregated said timing differences for each pair of said plurality of base stations;
d) reducing errors in combined said timing differences; and
e) adjusting base station timing responsive to said combined timing differences.

21. A method as in claim 20, wherein said plurality of base stations initiate timing difference measurements in step (a), mobile units served by said plurality of base stations measure transmission timing differences between said pairs, each of said mobile units returning said measured transmission timing differences to a server base station.

22. A method as in claim 21, wherein said timing differences are timing differences relative to a sub-unit of transmission for the wireless technology.

23. A method as in claim 20, wherein the step (b) of aggregating said measured timing differences comprises the steps of:
i) extracting an absolute timing difference (ATD) from each measured timing difference; and
ii) averaging extracted ATDs.

24. A method as in claim 23, wherein said averaging step (ii) averages said ATDs with a moving weighted average.

25. A method as in claim 23, wherein said mobile units measuring base station timing differences extract ATDs in extracting step (i).

26. A method as in claim 20, wherein the step (c) of combining said aggregated timing differences includes transferring said aggregated timing differences from said plurality of base stations to a central entity.

27. A method as in claim 20, wherein a network graph being formed in the step (d) of reducing errors, the error reducing step (d) comprising the steps of:
i) representing each of said plurality of base stations being represented as a graph node;
ii) providing links between pairs of graph nodes, each of said link representing the availability of a combined said timing differences between each corresponding represented pair of said plurality of base stations;
iii) identifying paths between nodes, identified said paths defining timing difference relationships between said nodes; and
iv) reducing errors from defined said timing difference relationships.

28. A method as in claim 27, wherein the step (iii) of identifying paths comprises identifying distinct loops in an ordered list, each distinct loop being an identified path and having at least one link not included in any earlier listed said distinct loop.

29. A method as in claim 20, wherein the base station adjustment step (e) comprises the steps of:
i) selecting a reference base station from said plurality of base stations;
ii) calculating a timing synchronization adjustment relative to said reference base station for each remaining one of said plurality of base stations;
iii) providing calculated timing adjustments to corresponding base stations; and
iv) adjusting base station timing responsive to provided said calculated timing adjustments.

30. A method as in claim 29, wherein the reference base station includes a universal clock source.

31. A method as in claim 30, wherein said universal clock source is a global positioning system (GPS) receiver.

32. A method as in claim 30, wherein each said timing synchronization adjustment calculated in calculating step (ii) is calculated relative to a clock from said universal clock source.

33. A method for synchronizing the transmission timing of base stations in a wireless network comprising:
a) measuring a transmission timing difference between at least one base station pair;
b) adjusting said measured timing difference (MTD) to obtain an adjusted transmission timing difference;
c) extracting an absolute transmission timing difference (ATD) from said adjusted transmission timing difference;
d) transferring said ATD to a central network entity;
e) obtaining a transmission timing difference relative to a reference base station for at least one base station of said pair using said ATD;
f) reducing errors in said transmission timing difference;
g) obtaining a timing adjustment relative to said reference base station for said at least one base station of said pair;
h) transferring said timing adjustment to said at least one base station of said pair; and
j) applying said timing adjustment to transmission timing of said at least one base station of said pair.

34. The method of claim 33 wherein said adjusted transmission timing difference obtained in adjusting step (b) is transferred to a serving base station for extracting the ATD in extracting step (c).

35. The method of claim 34 wherein a mobile unit measures the MTD in the measuring step (a) and adjusts the MTD in the adjusting step (b) and provides said adjusted transmission timing difference to said serving base station.

36. The method of claim 35 wherein the mobile unit subtracts a propagation delay difference (P2−P1) for each said at least one base station pair from said MTD in the adjusting step (b), the difference (MTD−(P2−P1)) being provided to said serving base station, said difference being said ATD extracted in step (c) by said serving base station.

37. The method of claim 35 wherein for one base station in each pair of said at least one base station pair, in the adjusting step (b) the mobile unit subtracts a propagation delay (P2) from said MTD, the difference (MTD−P2) being provided to said serving base station, said ATD being extracted in step (c) by adding another propagation delay (P1) for the other base station in said each pair.

38. The method of claim 35 wherein for one base station of each pair of said at least one base station pair, in the adjusting step (b) the mobile unit adds to said MTD a propagation delay (P1), the sum (MTD+P1) being provided to said serving base station, said ATD being extracted in step (c) by subtracting another propagation delay (P2) for the other base station in said each pair.

39. The method of claim 34 wherein a fixed measurement unit measures the MTD in the measuring step (a) and adjusts the MTD in the adjusting step (b) and provides said adjusted transmission timing difference to said serving base station.

40. The method of claim 39 wherein the fixed measurement unit subtracts a propagation delay difference (P2−P1) from said MTD in the adjusting step (b), the difference (MTD−(P2−P1)) being provided to said serving base station, said difference being said ATD extracted in step (c) by said serving base station.

41. The method of claim 33 wherein a mobile unit measuring the MTD in the measuring step (a) and adjusting the MTD in the adjusting step (b) provides said adjusted transmission timing difference to a central entity for extracting the ATD in extracting step (c).

42. The method of claim 41 wherein the mobile unit subtracts a propagation delay difference (P2−P1) from said MTD in the adjusting step (b), the difference (MTD−(P2−P1)) being provided to said central entity, said difference being said ATD extracted in step (c) by said central entity.

43. The method of claim 33 wherein the step (d) of extracting ADTs comprises averaging ADTs for base station pairs.

44. The method of claim 33 wherein the step (d) of extracting ADTs comprises a moving weighted average according to:
ATD₁=ATD₁(n=1) and,
ATDₙ₊₁=(1−w)ATDₙ+wATDₙ₊₁(n≧1);
where,
ATDₙ=n^{th} absolute time difference (obtained after ATDₙ₋₁ and before ATDₙ₊₁)
ATDₙ=n^{th} value for moving weighted average
w=weight (0<w<1).

45. The method of claim 33 wherein the step (e) of obtaining said transmission timing difference comprises the steps of:
i) obtaining a network graph wherein each node represents a base station and each link between a pair of nodes represents an available absolute transmission time difference between the pair of corresponding base stations;
ii) selecting an arbitrary reference node;
iii) finding a continuous path of nodes and links from said reference node to any other node; and
iv) summing the absolute transmission timing differences traversing along all links on said continuous path from said reference node to said other node.

46. The method of claim 45 wherein any said transmission timing differences summed in the step (iv) of summing are each differences of a first traversed node transmission time less a second subsequently traversed adjacent node transmission time.

46. The method of claim 45 wherein any said transmission timing differences summed in the step (iv) of summing are each differences of a second traversed node transmission time less a first previously traversed adjacent node transmission time.

47. The method of claim 33 wherein the step (f) of reducing errors includes averaging said ATDs for each pair of base stations.

48. The method of claim 33 wherein the step (f) of reducing errors comprises:
i) obtaining a network graph wherein each node represents a base station and each link between a pair of nodes represents an available ATD between a corresponding base station pair;
ii) identifying closed loops in said network graph;
iii) listing said closed loops in an ordered list in ascending order, according to the number of said nodes;
iv) traversing said ordered list in ascending order and removing all closed loops from said ordered list having links in earlier traversed closed loops, each remaining listed loop being a distinct closed loop including at least one link not in any other of said distinct closed loops appearing earlier in said ordered list;
v) producing an equation for each closed loop of nodes still remaining in said ordered list, each said equation summing the ATDs plus error component variables along all the links in said each closed loop, each said sum being equal to zero;
vi) producing additional equations, relating said error component variables, equal in number to the number of distinct links in all closed loops less the number of closed loops;
vii) solving said equations for said error component variables in said ATDs;
viii) obtaining an adjusted value for each ATD, said adjusted value including the corresponding error component obtained from said equations;
ix) selecting a reference node; and
x) summing said adjusted values along a sequence of links on a path from said reference node to each other node, each sum being the transmission timing difference from said reference node to said each other node.

49. The method of claim 33 wherein the step (f) of reducing errors comprises:
i) obtaining a network graph wherein each node represents a base station and each link between a pair of nodes represents an available ATD between a corresponding base station pair;
ii) selecting a reference node;
iii) for each remaining node, obtaining a set of minimum paths from said reference node to said remaining node, no link being in more than one path;
iv) for each path, identifying alternative sub-paths, each identified alternative sub-path connecting two nodes in said each path and including links that are not in any said path or in any other said identified alternative sub-path;
v) for portions of sub-paths, identifying alternative sub-paths, each identified alterative sub-path connecting two nodes in said sub-path portion and including links that are not in any said path, any of said sub-paths or other said sub-path portions;
vi) repeating step (v) until all said alternative sub-paths are found; and
vii) summing ATDs along all said paths, sub-paths and sub-path portions, ATD sums for each said path, sub-path and sub-path portion being summed with a weighted average, said weighted average being a transmission timing difference between said reference node and said remaining node, weights being assigned to each of said ATD sums and to each of said combined ATD sums inversely proportional to its variance;
whereby, variance is calculated for independent delays between pairs of nodes with zero error expectation and a common error variance, and said weighted average minimizes the variance of said transmission timing difference sum between path nodes.

50. The method of claim 33 wherein the step (g) of obtaining said timing adjustment includes dividing said transmission timing difference by a transmission time unit, said timing adjustment being obtained from the remainder.

51. The method of claim 33 wherein the step (g) of obtaining said timing adjustment includes the steps of:
i) receiving a current complete transmission timing reference from each of said base stations;
ii) adjusting each received said complete transmission timing reference for a propagation delay to said central network entity from said each of said base stations;
iii) approximating a complete transmission timing difference between said reference base station and each said base stations from the difference between said current complete transmission timing references for each of said base stations;
iv) combining each approximated said complete transmission timing difference with a transmission timing difference relative to a sub-unit of transmission for the wireless technology, whereby said combination yields a
$$\begin{matrix}precise complete time difference = ( n S + {t}^{*} ) if {t}^{*} \geq t , \\ = ( ( n + 1 ) S + {t}^{*} ) if {t}^{*} < t , \end{matrix}$$
where
S=said sub-unit of transmission
t*=said timing difference relative to S (0≦t*<S)
n S+t=lower bound of said approximate complete time difference
n S+t+E=upper bound of said approximate complete time difference
E=uncertainty range where E<S is required
0≦t<S
n is an integer with n≧0; and
v) dividing said precise complete transmission timing difference by a second sub-unit of transmission time, said timing adjustment being obtained as the remainder.

52. The method of claim 33 wherein the step (g) of obtaining transmission timing adjustments comprises the steps of:
i) assigning a time adjustment value of zero to the reference base station;
ii) obtaining a forward time adjustment and a backward time adjustment relative to said reference base station for every other base station;
iii) assigning a positive value to each said backward time adjustment and a negative value to each said forward time adjustment;
iv) finding a minimum range of values including a timing adjustment offset for every said base station;
v) choosing a new reference time based responsive to said minimum value range; and
vi) obtaining a new timing adjustment for each said base station relative to said new reference time and offset by a corresponding said timing adjustment offset within said minimum range.

53. The method of claim 52 wherein said timing adjustment offset in step (iv) is a forward adjustment.

54. The method of claim 52 wherein said timing adjustment offset in step (iv) is a backward adjustment.

55. The method of claim 52 wherein said new reference time is chosen in step (v) by selecting a new reference base station.

56. The method of claim 52 wherein said new reference base station is one said base station having a timing adjustment in the middle of said minimum range of values.

57. The method of claim 52 wherein said new reference time is between a pair of base station adjustments in the middle of said minimum range of values.

58. The method of claim 33 wherein the step (i) of applying said timing adjustments comprises adjusting base station transmission timing in each of said base stations over a selected period of time, applied said timing adjustments being spread over said selected period of time.

59. The method of claim 33 wherein the step (i) of applying timing adjustments adjusts timing in one of said base stations, immediately adjusting transmission timing in said one comprising the steps of:
i) handing over one or more served mobile units from said one to other base stations;
ii) allowing remaining served mobile units to complete current service requirements and refusing undertaking additional service requirements;
iii) applying the whole said transmission timing adjustment to base station transmission timing for said one; and
iv) resuming service for said one to mobile units.

60. The method of claim 33 further comprising the steps of:
j) maintaining a common time reference in said central entity for all said base stations;
k) transferring said common time reference to at least one unsynchronized base station; and
l) adjusting the transmission time of said unsynchronized base station to said common transmission time allowing for the additional propagation time from said central entity to said unsynchronized base station.

61. The method of claim 60 wherein said common time reference is provided to said central entity by one or more particular base stations.

62. The method of claim 33 further comprising the steps of:
j) synchronizing transmission timing in at least one base station to a universal time source;
k) assigning said at least one base station as said reference base station; and
l) calculating a timing adjustment for other said base stations relative to said reference base station.

63. The method of claim 62 wherein said universal time source is a GPS time source.

64. The method of claim 33, wherein at least one of said base stations includes a universal time source, said method further comprising the steps of:
j) periodically transferring the transmission timing of said at least one base station and a universal time count to said central entity;
k) synchronizing all of said base stations to eliminate transmission timing differences;
l) synchronizing each said at least one base station to universal time by applying a universal time adjustment;
m) assigning each synchronized said at least one as one said reference base station;
n) calculating a universal time timing adjustment for every other base station based on a difference between each said every other base station with a corresponding said reference base station; and
o) adjusting transmission timing in said every other base station according to said universal time adjustment.

65. The method of claim 64 wherein said universal time source is a GPS time source.

66. The method of claim 33 wherein mobile units in wireless communications with said base stations are GSM mobile units, said central network entity is a GSM SMLC and said measured timing differences are measurements for E-OTD positioning.

67. The method of claim 33 wherein mobile units in wireless communications with said base stations are GSM mobile units and at least one GSM mobile unit provides said transmission time differences to a new base station as part of handover from an old base station to said new base station.

68. The method of claim 33 wherein said transmission timing differences are event initiated, said event selected from a group comprising:
a command from said central entity;
a command from said server base station; and
a time periodic event.
